(19) United States
(12) Patent Application Publication
(10) Pub. No.: US 2013/0132720 A1
(43) Pub. Date: May 23, 2013

(54) SYSTEM AND METHOD FOR MULTI-DIMENSIONAL SECRETION OF DIGITAL DATA

(71) Applicant: Jon Parsons, Frisco, TX (US)

(72) Inventor: Jon Parsons, Frisco, TX (US)

(21) Appl. No.: 13/700,958

(22) PCT Filed: May 17, 2011
(86) PCT No.: PCT/US11/36815

§ 371 Date: Feb. 6, 2013

Related U.S. Application Data
(60) Provisional application No. 61/345,338, filed on May 17, 2010.

(51) Int. Cl. G06F 21/62

(52) U.S. Cl. CPC G06F 21/6227
USPC 713/167

(57) ABSTRACT

A system and method for multi-dimensional secretion of digital data. Digital data is received for secretion as a secret from one or more of a number of secretion parties. The secret is converted into a multi-dimensional object. The multi-dimensional object including at least four dimensions. Each of the plurality of secretion parties is assigned one of a number of dimensional attributes associated with the multi-dimensional object. The secret is recovered for the number of secretion parties in response to the number of secretion parties selecting a shape associated with the multi-dimensional object and providing all of the number of dimensional attributes previously associated with the multi-dimensional object.

### RELATED APPLICATIONS

This Application claims priority to PCT Application Serial No. PCT/US11/036815, filed May 17, 2011 entitled SYSTEM AND METHOD FOR MULTI-DIMENSIONAL SECRETION OF diGITAL data which claims priority to U.S. provisional patent application Ser. No. 61/345,338 filed on May 17, 2010, the entire contents of which are hereby incorporated by reference in their entirety.

### BACKGROUND

Encryption is the process of hiding data via an algorithm. The data is usually called a “secret.” The secret is commonly encrypted into cyphertext. The recovery of the secret from cyphertext may be returned as decryption. In computer systems, the secret is typically digital data and the encryption/decryption process uses mathematical algorithms. The system and processes of secreting and recovering digital data via mathematical encryption/decryption is a cryptosystem. Cryptosystems may utilize a method of disguising messages so that only certain people may see through the disguise

Cryptography is the art and science of creating and using cryptosystems. Cryptosystems and cryptography are often used in connection with electronic transactions and communications, such as electronic financial transactions. In some cases, a cryptosystem generates an encryption key that is used to encrypt a message, only a person that has a corresponding decryption key may decipher the message. Cryptosystems and cryptography may be utilized for various types of secure transactions. In many cases, carrying on secure transactions involving multiple parties utilizing crypto systems is unduly difficult, expensive, or complex. As a result, many communications and transactions remain unreceived.

### SUMMARY

The present invention relates generally to cryptosystems and cryptography, and relates more particularly to systems and methods involving aspects of multi-party cryptography in connection with authentication, digital signatures, and security of electronic communications including electronic financial transactions, and still more particularly to aspects of providing additional security and non-reputable use of shared knowledge in digital interactions.

One embodiment includes a system and method for multi-dimensional secretion of digital data. Digital data may be received for secretion as a secret from one or more of a number of secretion parties. The secret may be converted into a multi-dimensional object. The multi-dimensional object may include at least four dimensions. Each of the plurality of secretion parties may be assigned one of a number of dimensional attributes associated with the multi-dimensional object. The secret may be recovered for the number of secretion parties in response to the number of secretion parties selecting a shape associated with the multi-dimensional object and providing all of the number of dimensional attributes previously associated with the multi-dimensional object.

Another embodiment includes a system for multi-dimensional secretion of digital data. The system may include a cloud computing system accessible by one of a number of secretion parties. The system may further include one or more clients in communication with the cloud computing system through one or more communications networks. The one or more clients may be operable to receive digital data for secretion as a secret from one of the number of secretion parties and communicate the digital data to the cloud computing system. The cloud computing system may convert the secret into a multi-dimensional object. The multi-dimensional object may include at least four dimensions. The cloud computing system may receive a user selection of one of a number of attributes associated with the multi-dimensional object from the one or more clients. The cloud computing system may retrieve the secret and corresponding digital data for the number of secretion parties in response to the number of secretion parties selecting a shape associated with the multi-dimensional object and providing all of the number of attributes to the cloud computing system.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a system and model representing multi-dimensional secretion in accordance with an illustrative embodiment;

FIG. 2 is a pictorial representation of a multi-dimensional secretion system in accordance with an illustrative embodiment;

FIG. 2 is a pictorial representation of multi-dimensional secretion in accordance with an illustrative embodiment;

FIG. 3 is a pictorial representation of multi-dimensional exposition in accordance with an illustrative embodiment;

FIG. 4 is a pictorial representation of a multi-dimensional secretion and exposition in accordance with an illustrative embodiment;

FIG. 5A is a digital contracts use case in accordance with an illustrative embodiment;

FIG. 5B is a checks remittance case in accordance with an illustrative embodiment;

FIG. 5C is a digital media use case in accordance with an illustrative embodiment;

FIG. 5D is a medical records use case in accordance with an illustrative embodiment;

FIG. 6 is a flowchart of a process for storing digital data as a secret in accordance with an illustrative embodiment;

FIG. 7 is a flowchart of a process for retrieving digital data from a secret in accordance with an illustrative embodiment; and

FIG. 8 is a pictorial representation of a signet fill method for preserving integrity.

### DETAILED DESCRIPTION OF THE DRAWINGS

The illustrative embodiments provide a system and method for secreting digital data. The illustrative embodiments may be utilized with symmetric and asymmetric cryptosystems or a stand-alone cryptosystem. In one embodiment, the illustrative embodiments are implemented by virtually converting a two-dimensional digital object in linear form, such as the digital data that is the secret, into a multi-dimensional object also referred to as a signet. The digital data may be a file, funds, data, software, information, text, or other information. The multi-dimensional object may be stored in a virtual space with dimensional attributes providing keys to the two or more parties, all of which are required to access the secret.

The dimensional attributes describe or define the multi-dimensional object. The dimensional attributes may include values, vectors, formulas, time, sound, color, composition, texture, shape, and other features, characteristics or elements describing the multi-dimensional object in a manner that allows for the efficient identification, reconstruction, retrieval, and access of the multi-dimensional object as well as the internally stored secret.

The dimensional attributes may be described, embedded, or included in passwords, passkeys, public keys, private keys, or other identifiers (the illustrative embodiments may be implemented in hardware, software, firmware or a combination thereof). Multi-dimensional secretion of digital data may be utilized to capture and maintain the action of signing a digital object in a manner where the signature is bound with the signed object. In one embodiment, multi-dimensional secretion and exposition is performed by utilizing a cloud network including a number of servers or similar devices, and a number of client devices using browsers, or proprietary applications. The systems and processes herein described may be particularly useful for implement contracts, closings, negotiations, escrowing items, and so forth.

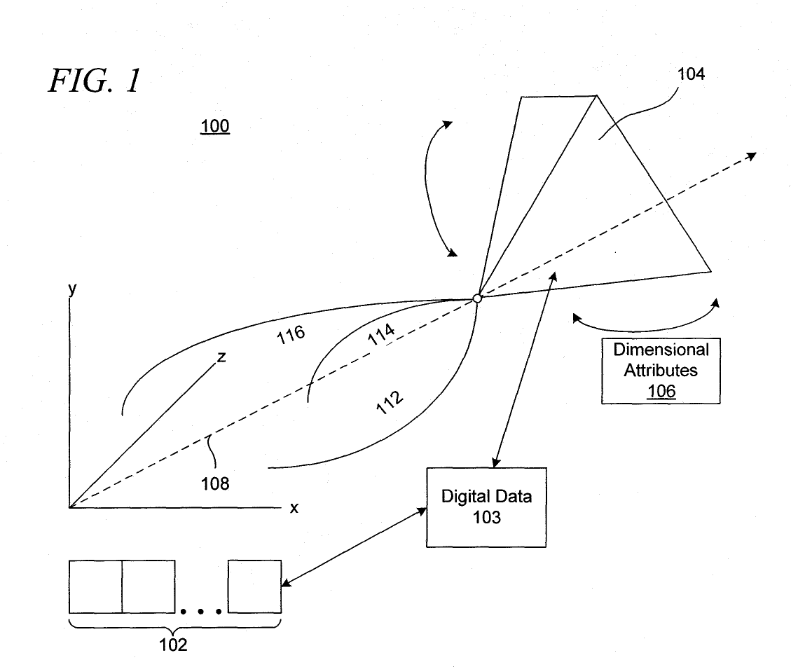

FIG. 1 is a pictorial representation of a system and model 100 representing multi-dimensional secretion in accordance with an illustrative embodiment. The model 100 may include any number of elements and configurations. In one embodiment, the model 100 includes secretion parties 102, digital data 103, a multi-dimensional object 104, dimensional attributes 106, object aspect 108, dimensional cells and locations 110, user inputs 112, 114, and 116. The model 100 represents operation of a computing and communications system implemented on a single or multiple devices and accessible to a fiduciary which may be one of the secretion parties 102. In one embodiment, the fiduciary or service provider may host a multi-dimensional secretion and exposition service

The secretion parties 102 are the parties secreting the digital data 103. The digital data may be electronic contracts, legal documents, documents requiring notarization, visual and audio media, exchange of monetary value instruments (checks, invoices, etc), government forms, images of physical documents or objects, or other instruments requiring signatures, legal identification of one or more parties to a contract, or verification that the instrument remains unchanged. The digital data 103 corresponding to the multi-dimensional objective may be stored in a three-dimensional database or three dimensional model within cloud computing environments, systems, equipment, devices, or networks. However, the digital data may be stored in any memory or storage element physically or virtually configured for storing data or information. The digital data 103 may also be controlled and accessed utilizing service oriented architectures (SOA), software as a service (SaaS), or other network environments.

In one embodiment, the digital data 103 may be secreted in one or more secured portions of the cloud environment. Similarly, the multi-dimensional object 104 may be stored at a virtual location selected by the combination of input provided by each of the secretion parties. However, in other embodiments, the three-dimensional database may be publicly available because of the various measures securing the digital data 103. In one embodiment, the digital data 103 may or may not be encrypted and stored within data or a binary enlarged object stored within the database. The content of the database may be described by three or more indices. The indices may be utilized to determine the location of the multi-dimensional object and corresponding digital data when properly extracted.

The secretion parties 102 may represent parties that are signatories, fiduciaries, or interest parties of a transaction, agreement, or secured process. In one embodiment, the secretion parties 102 may include a fiduciary that manages and coordinates the setup, securing, and accessing the system to secure and later retrieve the secret. Examples of secretion parties 102 may include individuals, buyers, sellers, banks or financial institutions, organizations, an escrow company or service, witnesses, a notary, lawyers, or other verifying parties.

In one embodiment, the number of secretion parties 102 may be associated with the number of dimensional attributes 106 utilized to secure the digital data 103 as a secret and then later retrieve the digital data 103. Any number of secretion parties 102 and dimensional attributes 106 may be used in conjunction with multi-dimensional secretion. However, the dimensional attributes 106 generated by or provided to each of the secretion parties 102 is required to access and retrieve the secret. The number of dimensional attributes 106 used and how the dimensional attributes 106 are selected may be a function of the legal requirements for the purpose for which the multi-dimension secretion is used and the demands of the entity or bearer tasked with ensuring the secret remains secured an inviolate until properly accessed.

The multi-dimensional object 104 is an object securing the digital data 103. The multi-dimensional object 104 may alternatively be referred to as a signet. In one embodiment, the multi-dimensional object 104 is a three dimensional shape. For example, the multi-dimensional object 104 is shown in FIG. 1 as a pyramid. The shape-based formula of the multi-dimensional object is not stored within the object, but instead may be required to be provided by the secretion parties and is verified by successful retrieval of the secret. For example, the dimensional attributes 106 may provide x, y, and z components of the object shape. The shape of the multi-dimensional object 104 may be selected by a user or jointly by consensus of the secretion parties.

The dimensional attributes 106 are attributes, features, elements or characteristics of the multi-dimensional object 104. The number and type of dimensional attributes 106 is nearly unlimited. The secret represented by the digital data 103 may be encrypted into the multi-dimensional objects possessing at least four dimensions including a “x” coordinate, a “y” coordinate, a “z” coordinate and a three-dimensional shape “f(x,y,z).”

In one example, the dimensional attributes 106 may include a slope (S ₐ) of center or media line of the multi-dimensional object 104, number of (x,y,z) cells (V_{S}) in the multi-dimensional object 104 corresponding to the actual or maximum file size of the digital data 103, color of the multi-dimensional object 104, such as red, formula F_{S} for the multi-dimensional shape in cells (i.e. V_{S}=⅓(Object Height×Object Base), audio associated with the multi-dimensional object 104 (i.e., mp3 or .wav), and locus (L_{(xyz)}) identified by X, Y, and Z values. In some cases, the dimensional attributes 106 may only include essential attributes that define the multi-dimensional object 104.

The multi-dimensional cells and cell locations 110 may include object cells V_{S} equating to the file size in bits or bytes. The object cells or the volume of the multi-dimensional object 104 may require a volume sufficient to store the digital data 103 of the secret plus the dimensional attributes 106. The dimensional attributes 106 may be referenced against the indices of a database or other storage element storing the multi-dimensional object 104 to retrieve the secret and associated digital data 103.

In one embodiment, if a user uses a linear algebraic formula as an attribute (which would be the case if the user utilized digital certificate keys). For example, the linear algebraic formula of the digital certificate keys may be used as part of the equation for the signet, such as one of the sides of the signet. As a result, part of the equation representing the attributed may be used to determine an X, Y or Z intercept of a the user's Cartesian coordinate attribute or within another non-geometric or trig metric formula that would generate a unique value for the coordinate. If any of these methods are used, then the user's attribute would be both a value in the indices of the database and a part of the formula for the location or creation of the signet. Object cells may be binary large object or equivalent data types. The number of bytes of the signet that contains a document may be equal to approximately 110% of the original file or document size.

The secretion parties 102 may set the object aspect 108 Sₐ using 360° with respect to the x, y, and z axis. In one embodiment, the object aspect 108 may changed in increments of 45°. In the example of FIG. 1, the center line of the multi-dimensional object 104 is positioned where x=y=z.

In one embodiment, the fiduciary may create the multi-dimensional object 104 using the formula for an equilateral pyramid. The fiduciary may use the formula for the multi-dimensional object 104 to convert the digital data 103 and the dimensional attributes 106 to the multi-dimensional object 104.

The user inputs 112, 114, and 116 are the inputs or signatures provided by the secretion parties 102. In the example of FIG. 1, there are three user inputs 112, 114, and 116 corresponding to the respective secretion parties 102. The user inputs 112, 114, and 116 may corresponding with the number of secretion parties 102 and defined dimensional attributes 106 of the multi-dimensional object 104.

The fiduciary may establish the virtual x, y, and z axis of the model 100 that establishes coordinate boundaries. In a system where the fiduciary may store the multi-dimensional object 104 in a three dimensional database of nearly infinite size, such as cloud computing, the fiduciary may make the values common between two or more fiduciaries.

The fiduciary or systems operating the model 100 transpose the bits of the digital data 103 in a two dimensional file into cells of a three dimensional array that stores the bits in a manner mapped to and determined by the formula for the multi-dimensional object 104. The transposed multi-dimensional object 104 may be stored or handled by the fiduciary as a binary file. The binary file represents any type of digital information converted into a unique and user-identifiable object that includes the process of creating the secret objects and the secret itself in an inseparable manner.

In one embodiment, once the multi-dimensional object 104 is established, the digital data 103 is secured by placing each byte or bit of the digital data in Cartesian or polar locations within the area of the selected three-dimensional object. For example, a digital array is generated within the three dimensional array and database. The digital array may be constrained by the volume (in whole integers) of the multi-dimensional object 104. The address of each cell within the digital array is a unique Cartesian or polar location within the area of the multi-dimensional object. The limits of the digital array may be required to be equal to or greater than the volume (number of bytes or bits in the digital data 103) plus the bytes or bits representing the dimensional attributed utilized to identify and locate the object. For example, the dimensional attributes 106 may not include the volume of the multi-dimensional, but may include the formula for the shape of the multi-dimensional object.

Encryption may be utilized at any time during the described processes to further secure data and information, obtaining digital signatures, electronic authentication or to further secure passwords, dimensional attributes, multi-dimensional objects, or other elements of the described systems and methods. In one embodiment, symmetric or asymmetric cryptosystems may be utilized. Symmetric cryptosystems may use the same key (a secret key) to encrypt and decrypt content. Asymmetric cryptosystems may use one key (for example a public key) to encrypt content and a different key (a private key) to decrypt the content. Asymmetric cryptosystems may also be referred to as “public key” or “public key/private key” cryptosystems.

The illustrative embodiments may be utilized for multi-linear or multi-dimensional encryption situations to efficiently handle situations in which two or more parties are required to store, manage, and access a secret in a non-reputable manner. For instance, digital (virtual) implementations of two key secure lock boxes, notarized documents or transactions, third-party verified financial transactions, or witnessed legal documents are various examples of multi-linear implementations. The different uses for multi-dimensional secretion may require non-reputable secretion by more than two parties these functional interactions between secretion parties are multi-dimensional because they are represented, at a minimum, as a function of x, y and z [f(x,y,z)].

In one embodiment, the virtual location of the multi-dimensional object 104, or dimensional attributes 106 may include a time (t) dimension. The time dimension may exist as a specific time or time window (after 1500 EST, May 22, 2010 and before 1500 EST, May 23, 2010) for providing the input for conversion of the digital data 103 into the multi-dimensional object 104 and the time dimension may exist as a specific time or time window (after 1500 EST, Jun. 22, 2010 and before 1500 EST, Jun. 23, 2010) for retrieving the digital data. For example, the object may be automatically deleted, corrupted, or require an additional key after that time or time range.

The dimensions utilized in multi-dimensional secretion may be, but are not limited to, values within a multi-dimensional mathematical context. For example, the coordinates of a location or the formula of the multi-dimensional object 104 are dimensions. The dimensions corresponding to the dimensional attributes 106 form the values, formulas and instructions used to convert and recover the digital data 103. With the exception of the formula of the multi-dimensional object, the dimensional values for conversion and extraction represented by the dimensional attributes 106 may be discrete or a range of values. For example, x, y, and z values may be a discrete value or range of values where x, y, and z would be valid. Exposition requirements may not have to be as stringent as those for secretion. If the fiduciary or service provider desires, they may require the exposition recipients to provide a valid value within a range of values to recover the item within the multi-dimensional object. For example, one of the secretion parties may be allowed to provide a value for the X Cartesian coordinate within a range of the actual coordinate plus or minus 10. The fiduciary may still require the exact coordinates to fully recover the secreted object.

In one embodiment, the processes herein described may be implemented by a server, server farm, computing or communications devices, or one or more network devices in communication with one or more users through wired or wireless networks. In one embodiment, the server or other device may include one or more processors or processing components for executing programs, applications, operating systems, kernels, set of instructions, or other software that may be executed to perform the methods, processes and features herein described. In one embodiment, the set of instructions may be stored in one or more memories and caches. The memory may be a volatile or non-volatile memory that may be integrated with or separate from the server or other device. In one embodiment, the memory is a database accessible by a numerous devices.

In another embodiment, dedicated hardware, logic, chips, or components may be utilized to perform the illustrative embodiments. For example, an application-specific integrated circuit (ASIC) may include the transistors, logic, and other hardware components for implementing the illustrative embodiments. In another embodiment, a field-programmable gate array may be programmed to perform the described process. The server or other devices understandable include any number of additional components, such as processors, memories, busses, motherboards, chipsets, interfaces, communications lines, caches, and similar hardware and software that are known to those of skill in the art. In addition to software instructions, digital logic may also be utilized to store and implement the described embodiments.

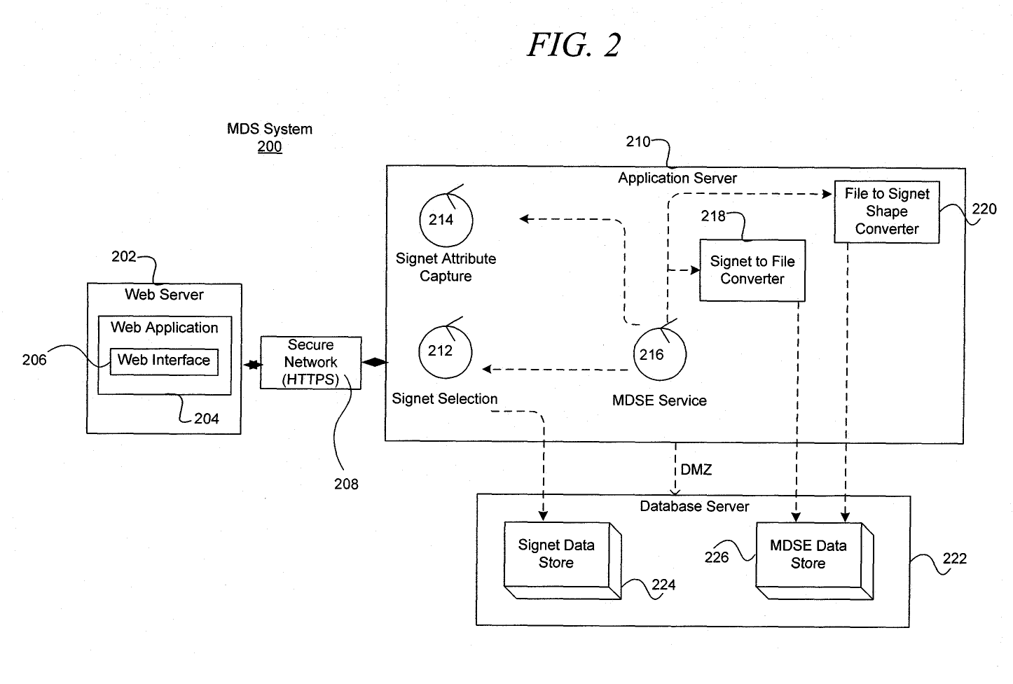

FIG. 2 is a pictorial representation of a multi-dimensional secretion system (MDS) 200 in accordance with an illustrative embodiment. The multi-dimensional secretion system 200 (also referred to as multi-dimensional secretion and exposition (MDSE)) may be utilized in any number of configurations including systems, equipment and devices. The embodiment of FIG. 2 shows one embodiment of components utilized to implement the MDS system 200 and associated processes (i.e., those shown in FIG. 1).

In one embodiment the MDS system 200 may include a web server 202 including a web application 204 and a web interface 206. The elements of the MDS System 200 may communicate utilizing a cloud environment of private and/or public networks. For example, the elements of the MDS system 200 may communicate through or utilizing a secure network 208. The secure network 208 may be a virtual private network (VPN), network tunnel, or other physically or virtually secured network. In one embodiment, the secure network 208 may utilize protocols, standards, encryption, certificates, or other process known in the art to secure data communicated through the secure network 208. The secure network 208 may include a plurality of networks communicating and may, in some cases, include public networks to communicate information utilizing secured methods and processes.

The MDS system 200 may further include an application server 210, a signet selection 212, signet attribute capture 214, an MDSE service 216, a signet to file converter 218 and a file to signet shape converter 220. The MDS system 200 may further include a database server 222 including a signet data store 224 and a MDSE data store 226.

In some cases the MDS system 200 and methods may be particularly useful for implementation utilizing web-based browser technologies. However, potential uses are not limited to browser technologies. For example, the MDSE system may be utilized with any application, generic or proprietary, or user interface that digitally presents the signet and allows input of the necessary dimensional attributes. For example, the MDS system 200 may be utilized across computing or communication devices as an “app” for sharing and securing information.

The web server 202 represents a commercially available web server 202 that may communicate with one or more web or network based interfaces. In one embodiment, the web application 204 and web interface 206 may be a web browser such as Internet Explorer, Firefox, Chrome, Safari or other similar web interfaces. In one embodiment, each party that participates in secured transaction may access the web application 204 and web interface 206 to participate in the original conversion and secretion of the digital data and subsequently, the retrieval of the digital data based on the required keys. The web application 204 and web interface 206 may also represent applications (or wireless “apps”) that may be accessed or executed locally or remotely by a fiduciary, owner, user, or other party.

In one embodiment, the signet selection 212 is a module or software component that may form and present three-dimensional representations of signet shapes to a user interface such as the web interface 206, and allows the user to select a desired shape. The signet shapes available or utilized may be user-selected, pre-programmed, or randomly selected for each new transaction. The size of the signet shapes may also correspond to the size of the secret represented by the digital data.

The signet attribute capture 214 is a component that captures all dimensional attributes of the signet including locus values. The locus values are one or more collection points which share a property regarding the multi-dimensional object.

The MDSE service 216 is a module that may include and execute all of the business logic necessary to implement multi-dimensional secretion and exposition. The MDSE service 216 may include shape selection, shape aspect line, locus values, required dimensional attributes, and optional dimensional attributes. The MDSE service 216 may be hosted by the fiduciary or made available to the secretion parties via a network or Internet cloud computing service.

The signet to file converter 218 is a module that receives all of the inputs including dimensional attributes from the users and converts a signet to a file. The file to signet shape converter 218 receives all of the inputs from the users and converts a file to the designated signet.

The database server 222 is a server dedicated to storing, managing and accessing a number of databases. The database server 222 may be utilized to store digital data for numerous ongoing transactions at any one time. In one embodiment, the database server 222 is accessible through a cloud computing service or environment.

The signet data store 224 is a database of the formulas that may be required for rendering a signet. The signet data store 224 may also include the business rules for attributes required for signet storage and the attributes required for signet retrieval in a modifiable or read-only form.

The MDSE data store 226 is a database that stores secreted data signets. For example, the MDSE data store 226 may be a multi-dimensional shared database. For example, the system and methods of FIG. 2 and the illustrative embodiments may be implemented using existing relational databases with object exchange or transfer. The MDSE data store 226 may also be accessed through a public or private network or through a cloud computing system.

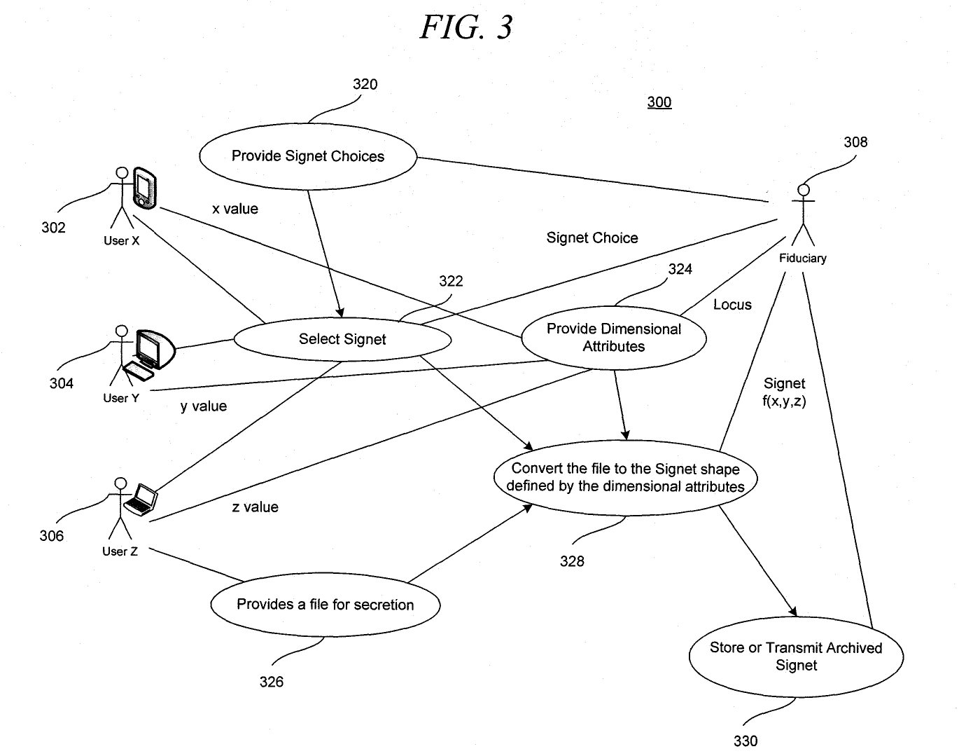

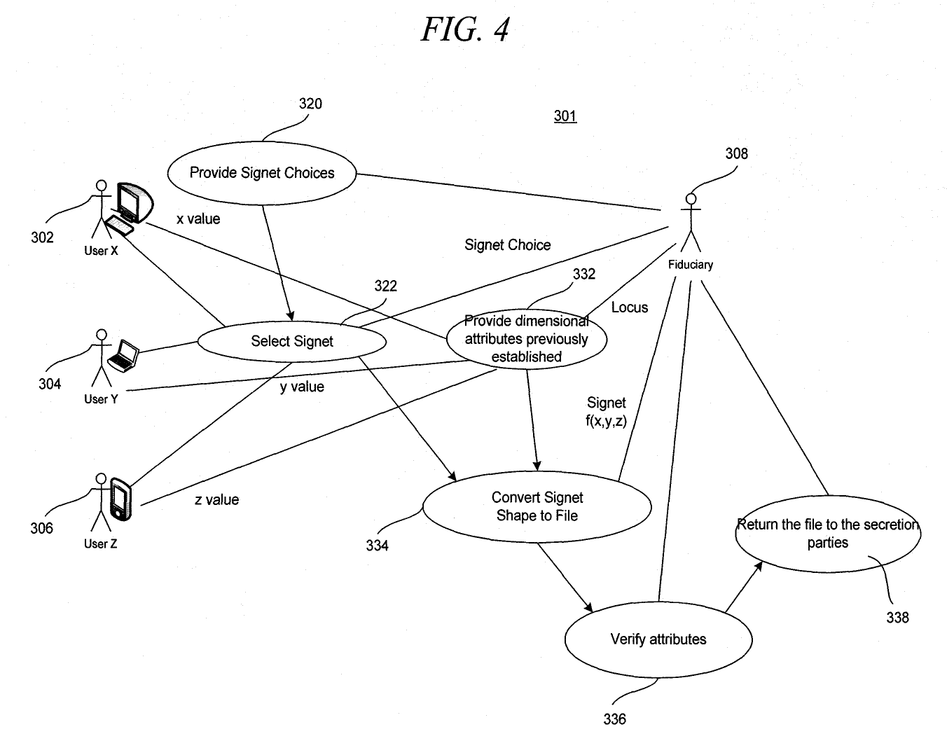

FIG. 3 is a pictorial representation of multi-dimensional secretion in accordance with an illustrative embodiment. FIG. 3 shows one example of a workflow 300 for safely storing digital data for access by a number of parties. Multi-dimensional secretion may be explained using any number of elements and components which may include user X 302, user Y 304, user Z 306, fiduciary 308, as well as various steps In one embodiment, the user X 302, user Y 304, user Z 306, may come to the fiduciary 308 to ceremonially secrete a digital file. In another embodiment, the fiduciary may act as or be a user, such as user Z 306. Each of the users and the fiduciary 308 may access a system, network, cloud environment, or device utilizing a computing or communications device to implement the processes herein described. The workflows 300 and 301 of FIG. 3-4 may utilize all or portions of the model 100 of FIG. 1 and the MDS system 200 of FIG. 2.

In one embodiment, the process may begin with the fiduciary 308 providing signet choices (step 320). The signet choices may include a visual or textual description of available signet choices. For example, user x 302, user Y, 304 and user Z 306 may be displayed a sphere, a cube, a pyramid, or 3-dimensional trapezoids, pentagons, hexagons, pentagons, and any number of other three dimensional shapes. Alternatively, the user or users may create or draw their own shape. Next, one or more of the user X 302, user Y 304, user Z 306, and fiduciary 308 may select the signet. In one embodiment, if a signing ceremony is not the required, the fiduciary 308 may also select the signet (step 322). In another embodiment, the user X 302, user Y 304, user Z 306, and fiduciary 308 may electronically select the signet as a group. The users also make choices and send the information to the fiduciary 308.

Next, user X 302, user Y 304, user Z 306, and the fiduciary 308 may provide dimensional attributes (step 324). The dimensional attributes may be locus values of the signet. The dimensional attributes may be a password that is mapped to a locus value, such as a vector defining a portion of the signet. In one embodiment, the dimensional attributes may be a user supplied identification and password that is mapped to a dimensional attribute of the signet. In another embodiments, the dimensional attributes may be randomly generated and provided to the user during step 324. For example, a fiduciary may decide that the signets in their storage will use Cartesian coordinates that are random number process-generated (RNP) values. For example, the fiduciary would assign a RNP value to a user supplied password and then us the RNP value as the signet attribute or Cartesian coordinate for the specified secretion party. The pattern may also be any number of mapping or conversion formats known in the art.

The user X 302, user Y 304, user Z 306, or the fiduciary 308 may provide the digital data for secretion. In the workflow 300, the user Z 306 provides a file for secretion (step 326). The file represents the digital data being secreted. For example, the file may be a Word document detailing a closing agreement that when signed by the necessary parties allows the closing to be completed.

Next, the fiduciary 308 converts the file to the signet shape defined by the dimensional attributes (step 328). During step 328, the fiduciary 308 secretes the signet into the multi-dimensional object and corresponding location using the dimensional attributes. In one embodiment, providing the dimensional attributes and converting the file into the signet defined by the dimensional attributes may be integrated (steps 324 and 328).

Next, the signet is stored or transmitted (step 330). In one embodiment, the signet may be embedded in a secure database accessible through a cloud environment. In another embodiment, the signet (f(x,y,z)) may be sent to a specified device or recipient for storage or archival until needed again and accessed through the proper authorization and verification.

FIG. 4 is a pictorial representation of a multi-dimensional secretion and exposition in accordance with an illustrative embodiment. FIG. 4 shows one example of a workflow 301 for accessing and retrieving digital data for access by a number of secretion parties including the user X 302, the user Y 304, the user Z 306, and the fiduciary 308. As before the secretion parties may be required to select the signet 322 based on a number of signet choices provided by a system or the fiduciary 308 (or manually selected). In another embodiment, the user may be required to draw or piece together the signet from multiple shapes, or linear or generic constraints. This first step authenticates that each of the secretion parties is authorized to access the file previously secured.

Next, the user X 302, the user Y 304, the user Z 306, and the fiduciary 308 provide the dimensional attributes previously established (step 332). The dimensional attributes may be required by the system to retrieve the signet. For example, the dimensional attributes may define the attributes of the signet for retrieving the signet from a stored location, such as size and vectors defining the digital data making up the file.

Next, the signet is converted to the file (step 334). The signet may be converted to the file from the database or storage element in which the signet was temporarily stored. In one embodiment, the signet is converted once the dimensional attributes are verified (step 336). Next, the file is returned to the secretion parties (step 338). In one embodiment, the file may be returned to the specific user or fiduciary that originally uploaded or presented the file to be secured.

In another embodiment, the users, fiduciary, or secretion parties that originally secreted the object may transfer their attributes to another party who may then use those attributes to recover or expose the object. For example, the multi-dimensional object may not be transmitted after secretion, instead the coordinates of the multi-dimensional object may be transmitted to another for recovery. The coordinates are not part of the data within the image and are instead metadata that may be added after the fact.

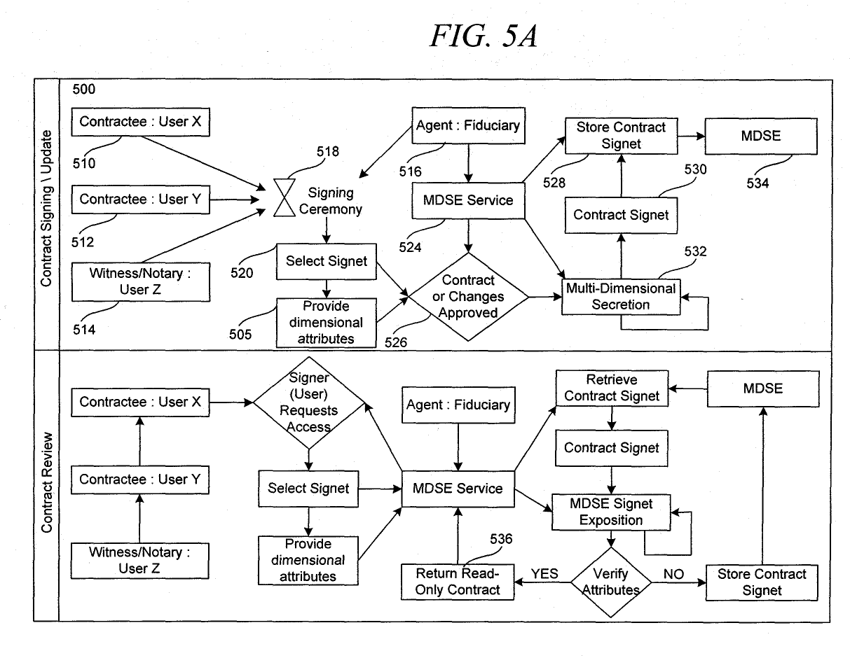

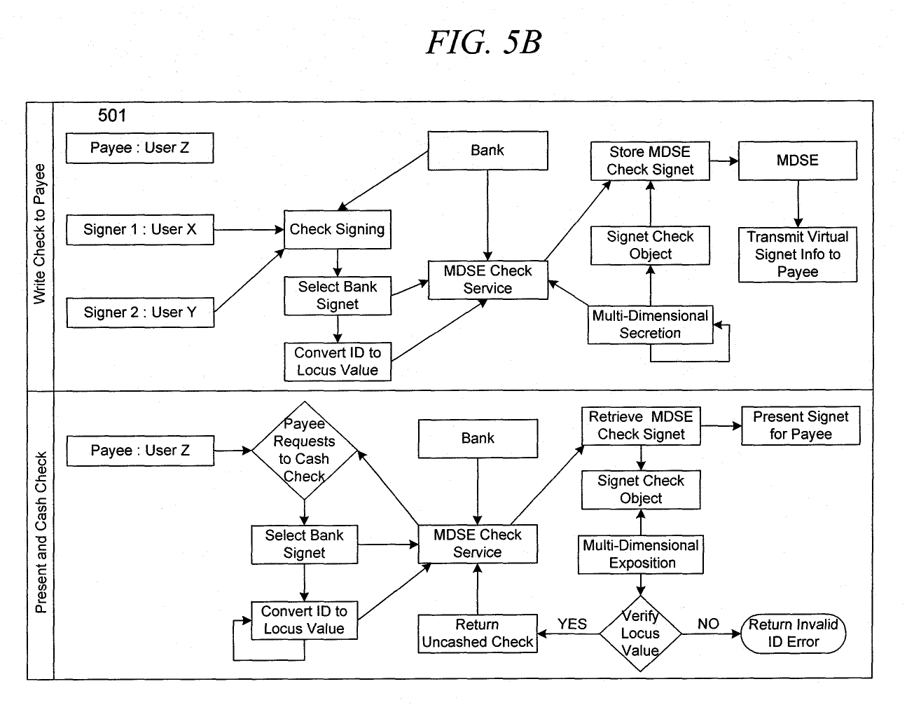

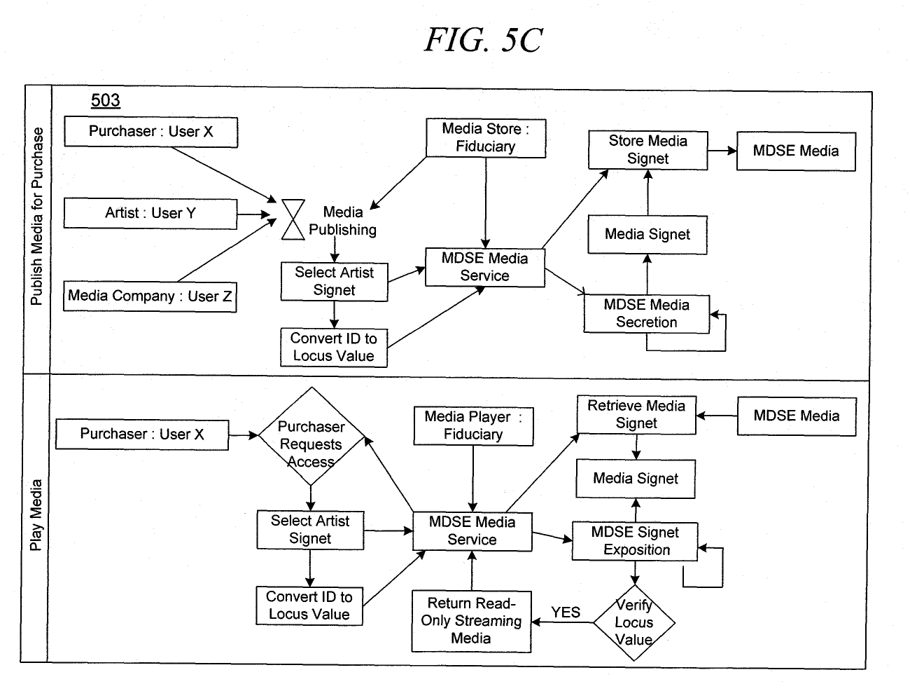

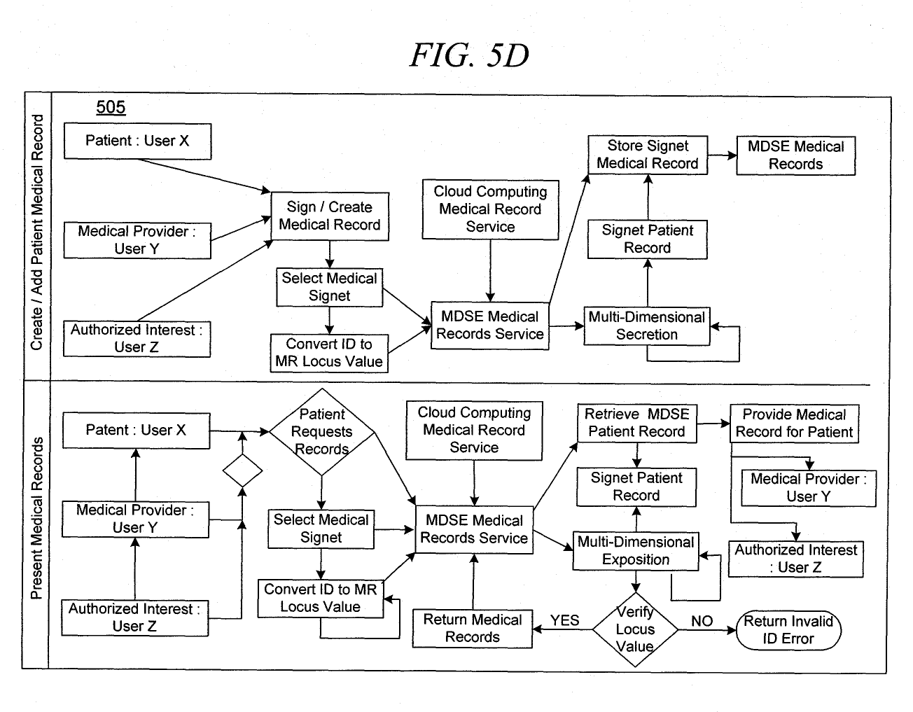

FIGS. 5A-D provide pictorial representations of use cases in accordance with illustrative embodiments. The elements of FIGS. 1-4 and 6-7 may include users, devices, systems, equipment, steps, processes or other elements that may facilitate description and understanding of the various use cases although not specifically shown in FIGS. 5A-5D. FIG. 5 is a digital contracts use case 500 in accordance with an illustrative embodiment. In one embodiment, the use case 500 illustrates utilizing MDSE to implement digital contract signing. The numbered elements of use case 500 illustrate an implementation of a digital contract signing in a MDSE system or process.

The creation of a digital contract may require a minimum of two parties such as user X 510 and user Y 512 and an entity, individual or a company to witness or notarize the execution of the signing ceremony 518, such as user Z 514.

MDSE is valuable because it requires all of the minimum activities and attributes to constitute a signing ceremony 518 in order to create valid digitally signed documents. The use case 500 may be utilized to generate or approve contract changes 526. Other steps and elements of the use case 500 may include selecting a signet 520, providing dimensional attributes 522, an MDSE service 524, approving a contract or changes to a contract 526, storing a contract signet 528, contracting a signet 530, multi-dimensional secretion 532, and MDSE 534. The MDSE service 524 includes and implements business rules that ensure a legally complete signing ceremony 518. In one embodiment, the MDSE service 534 may be hosted or provided by a fiduciary. In various illustrative embodiments the MDSE system and process provide the following:

A. Legal proceedings that may verify that signet attribute information provided by the secretion parties (users) is unique to each user, or if the encryption is used to create the attribute value, the user must provide the unique key or keys that create that value because the MDSE provider may not create and store the signet in a unique virtual location unless the user attributes are unique.

B. Legal proceedings may verify that signet attribute information provided by the user may be used to objectively identify the person signing the electronic record because the signet formula and aspect are not stored within the signet and the signet may not be recovered unless the owner provides the correct attribute, signet formula and aspect. All of the attribute providers would have to allow their attributes to be compromised for an unauthorized access to occur.

C. Legal proceedings may verify that signet attribute information provided by the user was reliably created by such identified person and that the attribute information may not be readily duplicated or compromised because, at the time the user provides the attribute value, the users also jointly (with other attribute providers and within a secure communication session) select the signet that will use that attribute. This act makes the other attribute providers or users witnesses that the attribute provision occurred. The MDSE provider also verifies that the user provided the attribute using an appropriately strong authentication mechanism. These two elements are combined to ensure the reliable creation of the attribute by the identified person.

D. Legal proceedings may verify that signet attributes are created and provided by the secret parties and linked to an electronic record to which the multi-dimensional object relates in a manner that, if the record is changed after signing, the electronic signature is invalidated. For example, signet recovery may only happen with the MDSE provider receives all of the correct dimensional attributes for the signet. If any dimensional attributes are changed, the recovery process is nullified.

The MDSE systems and processes may comply with legal requirements for electronic signatures, document authentication and performing contracts such as the statutes of Illinois, including Section 100.30 (Defining Criteria for Acceptance of Electronic Signatures) and other state and federal requirements.

The conversion of the digital file into the signet binds all of the secretion parties into an inseparable secreted object. Encryption may be added to the file before or after conversion into the signet to add additional security. Storage of the signet may simulate the storage of the signet at locus points in a three dimensional database. In one embodiment, a correct signet selection plus one correct dimension attribute may provide read-only access to the contract 536. A minimum selection or input of the correct signet plus all dimensional attributes may be required for modification of the contract. Read-only and full access may require separate process or databases for granting access to the secretion parties. In one embodiment, the read-only versions of the signet include a unique watermark. The watermark may be legible on the viewable documents and hidden in the inaudible or un-viewable segments of a media file.

FIG. 5B is a checks remittance use case 501 in accordance with an illustrative embodiment. Use case 501 may be utilized to implement digital checks or remittance advice. To create a digital check the MDSE service may require at least two dimensional attributes. Payee unique identification information as determined by the fiduciary may provide the third dimensional attribute. The payee or agent may be required to know the signet (which may include shape and aspect). Payment instructions may require three parties to execute. For example, the payee, payer, and the individual, party, or organization honoring the instrument would represent the three secretion parties when a two signature check is issued and exchanged. User X and user Y represent the two payees or signers. The fiduciary may fill the person honoring the instrument as an agent.

As with use case 500, the MDSE supports the execution of the signing ceremony for the instrument provided the fiduciary captures all of the signet and dimensional attributes. The value of the MDSE is that it requires all of the minimum activities and attributes to constitute a ceremony that creates a valid digitally-signed artifact. For example, a bank may represent the fiduciary or fiduciary's agent. In use case 502, the fiduciary may create the third dimensional attribute or z attribute utilizing asymmetric cryptography. The term “transmit” may be used figuratively with respect to the signet. The signet is virtually stored in three or more dimensions and the fiduciary transmits information necessary to allow the payee and his fiduciary to retrieve and honor the payment instrument. The fiduciary for the payee retrieves or receives the signet location information. The bank may need to have the ability to process the signet and the attributes to retrieve the signet without the payee locus information.

FIG. 5C is a digital media use case 503 in accordance with an illustrative embodiment. MDSE may be utilized to implement copy-protected downloaded digital media distribution. When a user X (the purchaser) buys digital media, the user may provide a dimensional attribute to the media store. Next, user Y (the artist) and user Z (the media company) provide their unique dimensional attributes during distribution. The artist or media company may pre-select their unique signet. The media store provides the fiduciary role and operates the MDSE media service. The media store creates the signet with the dimensional attributes from the purchaser, artist and media company. The media is downloaded in signet form to the purchaser. The purchaser provides their locus value and the artist/media company's signet to the player device. The player device converts the signet and validates the dimensional attribute of the purchaser. The player device provides streaming digital media version of the file. A valid dimensional attribute plus a valid signet may return a read-only version. All dimensional attributes may remain in the media header, if the media is copied and given to another user, the media will still identify the original purchaser. A new application or digital logic may be utilized for a media player to implement the preceding functionality.

FIG. 5D is a medical records use case 505 in accordance with an illustrative embodiment. In one embodiment, the patient may provide their individual dimensional attribute to create or update their medical records. The patient may also be required to pick a signet object for their records. The medical provider and an authorized agent of the patient may need to provide respective dimensional attributes to complete the creation or update of the digital medical records. The provider and the agent may provide the documents to be secured. A service-oriented cloud computing medical record service may act in the role of the fiduciary. The value of the MDSE in this use case 505 is that minimum activities and attributes are required to constitute a ceremony that creates a valid digitally-signed artifact. The record may be a single, expanded, or multiple signets. Implementation in a multi-dimensional database in a cloud computing service may optimize signet storage. Patients may utilize their dimensional attribute to authorize access to their records. The fiduciary may allow locus values for the provider and authorized interest that fit within a particular range. The fiduciary may verify that the medical provider or interest receiving the records have the authority to view/update the records.

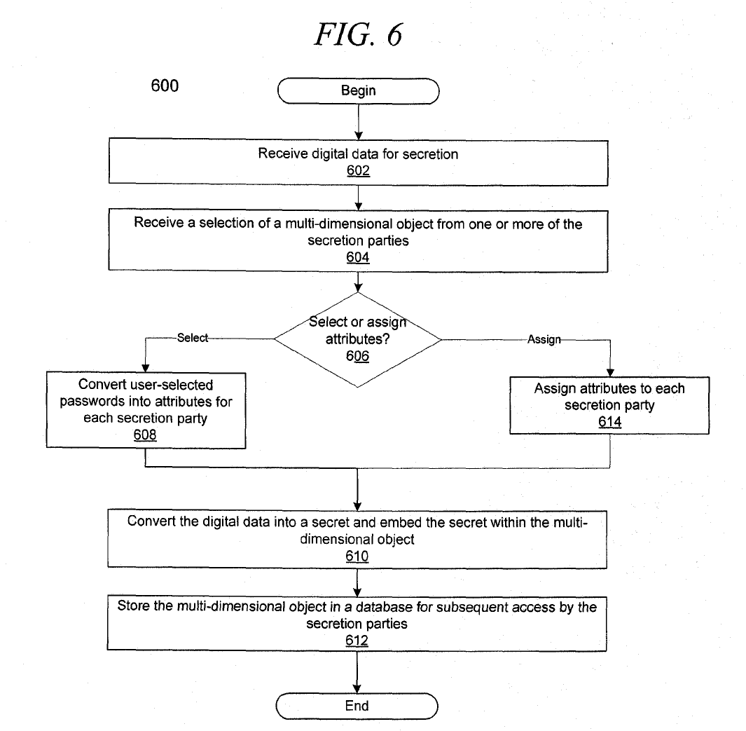

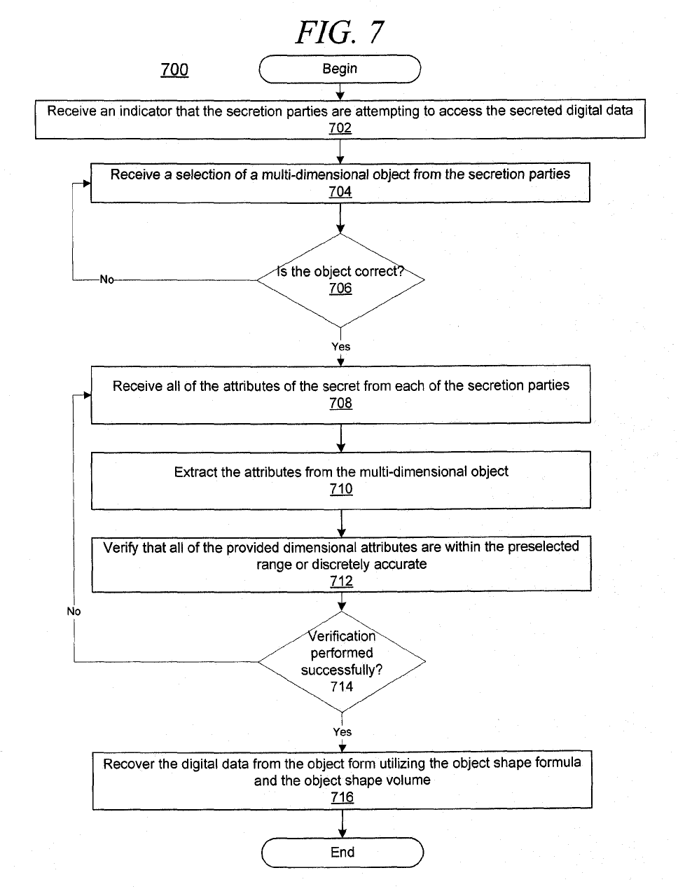

FIG. 6 is a flowchart 600 of a process for storing digital data as a secret in accordance with an illustrative embodiment. The process of FIG. 6-7 may be implemented by a user accessing a server integrated with a cloud environment, or other communications or computing device generically referred to as a “server” through a computing or communications devices. The computing or communications device may execute a browser, proprietary application, program, or other instructions to interact with the user and the server.

The process may begin by receiving digital data for secretion (step 602). The digital data may be uploaded, communicated, or generated on the server based on feedback by the secretion parties. As previously discussed the format and type of digital data may depend on the secretion needs of the secretion parties. For example, the digital data may be a hard copy document or photograph that is digitized for utilization and access of the secretion parties.

Next, the server receives a selection of a multi-dimensional object from one or more of the secretion parties (step 604). In one embodiment, one of the secretion parties may select the multi-dimensional object. In another embodiment, the secretion parties may vote or required to unanimously select the multi-dimensional object based on an electronic message or real-time communication between the secretion parties. Selection of the multi-dimensional object may provide a first obstacle for preventing would be hackers, thieves, or other unauthorized parties from accessing the digital data.

Next, the server allows a user to select or is assigned attributes (step 606). The system may be performed to prompt the secretion parties for attributes or to assign attributes based on a configuration, user preferences, or sophistication of the parties.

If the server allows the secretion parties to select attributes, the server converts user-selected passwords into attributes for each secretion party (step 608). In one embodiment, the passwords are mapped to vectors that define the object. The fiduciary or other party may use any number of algorithms to map a password to the locus/vector associated with the password. The attribute or password may also be a biometric, such as fingerprint, DNA, eye scan, facial recognition, or so forth.

Next, the server converts the digital data into a secret and embeds the secret within the multi-dimensional object (step 610). Step 610 may be performed one or more times at any stage during the process of FIG. 6 to add additional layers of security. For example, the database may be encrypted.

Next, the server stores the multi-dimensional object in a database for subsequent access by the secretion parties (step 612). The multi-dimensional object may be stored locally in the server or remotely in any number of storage systems. In one embodiment, the server is part of a secured cloud environment that stores a number of databases for multi-dimensional objects securing secrets for subsequent or ongoing access.

In response to determining to assign secretion parties attributes in step 606, the server assigns attributes to each secretion party (step 614). The attributes may be alphanumeric sequences, numeric sequences, files, pictures, or passwords that correspond to the attribute. Assigning attributes may ensure that the vectors and attributes defining the multi-dimensional object are completely random further complicating any potential attempts to retrieve the digital data during or after secretion of the digital data as a secret in the multi-dimensional object.

Further summarizing, the digital or virtual location of the multi-dimensional object is established by at least three secretions parties in at least three embodiments: 1)Three or more users provide a minimum combination of characters and letters (8 or more) that are converted to a value x, y, and z, respectively, 2)Three or more users provide a password that is converted by symmetric or asymmetric key encryption to a secret value for x, y, and z, respectively, 3)Three or more users provide a password that is converted to vectors to a secret value for x, y, and z, respectively. The secret values may be where the three vectors intercept. When elliptical curve cryptography (ECC) is used for establishing the object location, the one dimensional attribute of one or more of the secretion parties may be used to form the outer boundaries of the multi-dimensional object.

FIG. 7 is a flowchart 700 of a process for retrieving digital data from a secret in accordance with an illustrative embodiment. The process of flowchart 700 may be performed once or a number of times once the digital data has been secreted and stored in the multi-dimensional object. The process may begin by receiving an indicator that the secretion parties are attempting to access the secreted digital data (step 702). The indicator may be one or more of the secretion parties access the server, activating an interface, or otherwise providing input.

Next, the server receives a selection of a multi-dimensional object from the secretion parties (step 704). In one embodiment, each of the secretion parties may be required to supply a text description of the object, such as “trapezoid.” In another embodiment, each of the secretion parties may be required to select the multi-dimensional object from a number or page of objects. All or a portion of the secretion parties may be required to select the correct multi-dimensional object before the authentication process may continued.

Next, the server determines whether the object is correct (step 706). If the object is not correct, the server returns to receive a selection of a multi-dimensional object from the secretion parties (step 704). In response to numerous failed attempts the secretion parties may be temporarily denied access to the server and/or a number of failure messages may be sent to the secretion parties and other administrators.

If the multi-dimensional object is correct in step 706, the server receives all of the attributes of the secret from each of the secretion parties (step 708). The attributes may be required to access the secret within the multi-dimensional object. The attributes may be encompassed in words, information, data, biometrics or passwords based on selection of the secretion parties or the configuration of the system.

Next, the server extracts the attributes from the multi-dimensional object (step 710). In one embodiment, the attributes may be defined by a shape formula for the multi-dimensional object. The server verifies that all of the provided attributes are within the pre-selected range or discretely accurate (step 712). Step 712 may be performed by comparing the attributes provided by the secretion parties with the attributes of the multi-dimensional object independently obtained by the server. The MDS service provider may be responsible for establishing the algorithms for the creation and extraction of the signet attributes before the signet is created.

Next, the server determines whether the verification is performed successfully (step 714). If the verification is not performed successfully, the server returns to receive all of the attributes of the secret from each of the secretion parties (step 708). This process may be repeated a number of times until the secretion parties are locked out, messages regarding the verification failure are sent out, or an administrator intervenes.

If the verification is performed successfully in step 714, the server extracts or recovers the digital date from the multi-dimensional object utilizing the attributes (step 716). In one embodiment, the attributes may include the object shape, formula, and volume utilized to retrieve the digital data from the database. The digital data may be decrypted from the secret to present the digital data for the secretion parties. Further decryption of the object, attributes, multi-dimensional object, secret, or digital data may be required at any step of the process of FIG. 7. In some embodiments, decryption may be required before a next step may be performed. Once the digital data is presented to the secretion parties, the digital data may be utilized to complete the purpose for which it was originally made secret, such as complete a transactional closing of real estate. The process of FIGS. 6 and 7 may be particularly useful for electronic contract signing ceremonies, digital (virtual) implementations of two-key secure lock boxes, notarizing documents or transactions, third-party verified financial transactions, or witnessed legal documents.

In one embodiment, the database may be filled with secreted data as well as random data and the secreted data is retrieved from the database as described. Alternatively, secrets may be stored and then retrieved from multiple databases.

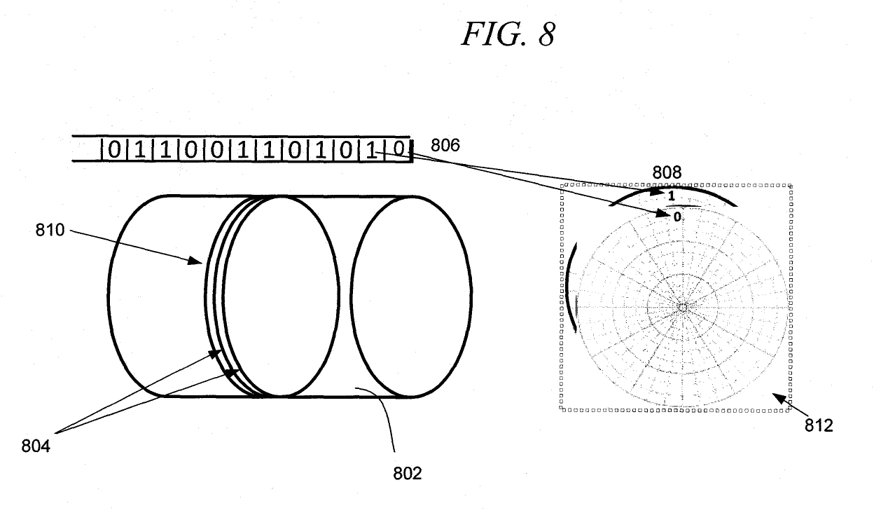

FIG. 8 is a pictorial representation of a signet fill process for preserving integrity. FIG. 8 illustrates both steps and elements of the signet process that may be implemented by a system, device, or instructions (generically referred to as a system for purposes of illustration). FIG. 8 further illustrates how a chained, layered, and filled multi-dimensional object from a linear, binary digital file. Likewise, the relationship between the cell value and the encoding algorithm is further illustrated.

In one embodiment, object 802 is divided into coordinate or grid addressable layers and select n (two or more) adjacent layers on a specific axis (x, y, z, or n) (step 804). Next, the system selects a bit or byte of the file to be encoded and the bit or byte n value is determined (i.e. Boolean parity value) (step 806).

Next, the system places the bit/byte in the first open addressable cell in the n addressable layer determined by the bit/byte n value (step 808). A pointer may be maintained for the next open addressable cell. The system continues to place bits/bytes into the addressable arrays for each layer until the array is filled.

Next, the system adds another layer to the n adjacent layers and drops the array for the filled layer (step 810). The system continues to use layers until the available encoding file bits/bytes are exhausted. Next, the system may use the non-object addressable cells of a layer for storing signature encrypted metadata to mask the object limits and to simulate unlimited three dimensional space (step 812).

Many aspects and features of the illustrative embodiments relate to, and are described in the context of the non-reputable secretion of digital data, using discrete values, symmetric or asymmetric keys, such as passwords, passkeys or public key/private keys. The illustrative embodiments are not limited by cryptography constraints though cryptography may be utilized as one step to further secure information as herein described. Particular embodiments relate to establishing a legal pattern of behavior called a “signing ceremony,” but that is one of many disclosed embodiments.

Each decryption step can be made to represent the steps of electronic contract signing ceremonies, digital (virtual) implementations of two key secure lock boxes, notarized documents or transactions, third-party verified financial transactions, or witnessed legal documents.

The previous detailed description is of a small number of embodiments for implementing the invention and is not intended to be limiting in scope. The following claims set forth a number of the embodiments of the invention disclosed with greater particularity.

What is claimed:

1. A method for multi-dimensional secretion of digital data, the method comprising:
receiving digital data for secretion as a secret from one or more of a plurality of secretion parties;
converting the secret into a multi-dimensional object, the multi-dimensional object including at least four dimensions;
assigning each of the plurality of secretion parties one of a plurality of dimensional attributes associated with the multi-dimensional object; and
recovering the secret for the plurality of secretion parties in response to the plurality of secretion parties selecting a shape associated with the multi-dimensional object and providing all of the plurality of dimensional attributes previously associated with the multi-dimensional object.

2. The method according to claim 1, wherein the multi-dimensional object is a virtual location.

3. The method according to claim 1, wherein the plurality of dimensional attributes are an x coordinate, a y coordinate, a z coordinate, and a three-dimensional shape of the multi-dimensional object.

4. The method according to claim 1, wherein the multi-dimensional object is selected by one or more of the plurality of secretion parties, and wherein the multi-dimensional object is stored in a virtual location of a three dimensional database.

5. The method according to claim 1, wherein one of the plurality of dimensional attributes includes a time dimension specifying a time window during which the secret is accessible.

6. The method according to claim 1, wherein the recovering further comprises:
determining the plurality of dimensional attributes provided by the plurality of secretion parties are correct; and
extracting the secret and corresponding digital data from the multi-dimensional object in response to determining the plurality of dimensional attributes are correct.

7. The method according to claim 1, wherein the digital data is converted by placing each byte or bit of the digital data in Cartesian or polar locations within a volume encompassed by the multi-dimensional object, the volume of the multi-dimensional object being sufficient to include the digital data and information for extracting the digital data.

8. The method according to claim 1, wherein the plurality of dimensional attributes define the at least four dimensions of the multi-dimensional object, the plurality of dimensional attributes being selected from the group consisting of an x coordinate, a y coordinate, a z coordinate, a shape, a color, texture, sound, time, or composition.

9. The method according to claim 1, further comprising:
three or more of the plurality of secretion parties providing a password or password encrypted by symmetric or asymmetric encryption that is converted to an x value, a y value, and a z value as the plurality of dimensional attributes individually assigned to each of the plurality of secretion parties, the x value, y value, and z value intersect.

10. The method according to claim 1, wherein the plurality of dimensional attributes are vectors or formulas forming the multi-dimensional object.

11. The method according to claim 10, wherein the plurality of dimensional attributes are locus values.

12. A system for multi-dimensional secretion of digital data, the system comprising:
a cloud computing system accessible by one of a plurality of secretion parties;
one or more clients in communication with the cloud computing system through one or more communications networks, the one or more clients are operable to receive digital data for secretion as a secret from one of the plurality of secretion parties and communicate the digital data to the cloud computing system, wherein the cloud computing system converts the secret into a multi-dimensional object, wherein the multi-dimensional object including at least four dimensions, wherein the cloud computing system receive user selection of one of a plurality of attributes associated with the multi-dimensional object from the one or more clients, and wherein the cloud computing system retrieves the secret and corresponding digital data for communication to the one or more clients associated with each of the plurality of secretion parties in response to the plurality of secretion parties selecting a shape associated with the multi-dimensional object and providing all of the plurality of attributes to the cloud computing system.

13. The system according to claim 12, wherein the one or more clients include wireless devices and computing devices, the one or more clients communicate with the cloud computing system utilizing an application operable to enable one or more of the plurality of secretion parties to provide the digital data for conversion into a secret, receive the plurality of attributes, and receive the digital data that is extracted from the secret in response to providing the plurality of attributes.

14. The system according to claim 12, wherein the attributes are vectors or formulas forming the multi-dimensional object. .

15. The system according to claim 12, wherein the multi-dimensional object is selected by one or more of the plurality of secretion parties, and wherein the multi-dimensional object is stored in a virtual location.

16. The system according to claim 12, wherein the secret is retrieved in response to determining the attributes provided by the plurality of secretion parties are correct, wherein the secret is extracted from the multi-dimensional object to reform the digital data in response to determining the attributes are correct.

17. The system according to claim 12, wherein three or more of the plurality of secretion parties each provide a password encrypted by symmetric or asymmetric encryption that is converted to an x value, a y value, and a z value as the plurality of attributes individually assigned to each of the plurality of secretion parties, the x value, y value, and z value intersect.

18. A server comprising:
a processor for executing a set of instructions; and
a memory for storing the set of instructions, wherein the set of instructions are executed to:
receive digital data for secretion as a secret from one or more of a plurality of secretion parties;
secrete the secret into a multi-dimensional object, the multi-dimensional object including at least four dimensions;
assign each of the plurality of parties one of a plurality of dimensional attributes associated with the multi-dimensional object; and
expose the secret for the plurality of secretion parties in response to the plurality of secretion parties selecting a shape associated with the multi-dimensional object and providing all of the plurality of dimensional attributes.

19. The server according to claim 18, wherein the server is integrated with a cloud computing environment accessible by the secretion parties utilizing a plurality of clients, wherein the dimensional attributes define the multi-dimensional object and identify each of the plurality of secretion parties, and wherein each of the secretion parties identifies a shape associated with the multi-dimensional object as one of the at least four dimensions to provide one of the plurality of dimensional attributes.

20. The server according to claim 18, wherein a fiduciary is one of the plurality of secretion parties, wherein the fiduciary manages the server, wherein the server communicates with a database to store the multi-dimensional object.
